(19) United States
(12) Patent Application Publication
(10) Pub. No.: US 2007/0291384 A1
(43) Pub. Date: Dec. 20, 2007

(54) Method of making reflector for solar collector or the like, and corresponding product, including reflective coating designed for improved adherence to laminating layer

(75) Inventor: Yei-Ping (Mimi) H. Wang, Troy, MI (US)

Correspondence Address: NIXON & VANDERHYE, PC, 901 NORTH GLEBE ROAD, 11TH FLOOR, ARLINGTON, VA, 22203, US

(73) Assignee: Guardian Industries Corp., Auburn Hills, MI (US)

(21) Appl. No.: 11/452,418

(22) Filed: Jun. 14, 2006

(51) Int. Cl. G02B 5/08

(52) U.S. Cl. 359/883; 359/838

(57) ABSTRACT

A reflector (e.g., mirror) for use in a solar collector or the like is provided. In certain example embodiments of this invention, a reflector is made performing at least the following steps: (a) forming a reflective coating on a flat glass substrate, (b) cold-bending the glass substrate with the reflective coating thereon; and (c) applying a plate or frame member (e.g., another glass sheet/substrate, or alternatively a thermoplastic member) to the cold-bent glass substrate, the plate or frame member for maintaining the coated glass substrate in a desired bent orientation. In certain example embodiments, the reflective coating is a mirror coating and includes a passivating film including tin oxide and/or silane(s) for better adhering to the polymer based glue/adhesive/laminating layer which may be made of polyvinyl butyral (PVB) or the like.

This application is related to U.S. Ser. Nos. 11/416,388 and 11/387,045, the entire disclosures of which are hereby incorporated herein by reference.

This application is related to a reflector (e.g., mirror) for use in a solar collector or the like. In certain example embodiments of this invention, a reflector for a solar collector or the like is made by (a) forming a reflective coating on a flat glass substrate, (b) cold-bending the glass substrate with the reflective coating thereon using a mold member; and (c) applying a plate member (e.g., thermoplastic or glass based) to the cold-bent glass substrate, the plate member for maintaining the coated glass substrate in a bent orientation. In certain example embodiments of this invention, the reflector may be used in a solar collector, or in any other suitable application.

In certain example embodiments, the reflective coating is specially designed to as to better adhere to a polymer based adhesive/laminating layer that is used to couple the plate member (e.g., glass sheet) to the cold-bent glass substrate. For example, in certain example embodiments, the reflective coating is a mirror coating and includes a passivating film comprising tin oxide and/or silane(s) for better adhering to the polymer based adhesive/laminating layer which may be made of polyvinyl butyral (PVB) or the like.

### BACKGROUND AND SUMMARY OF EXAMPLE EMBODIMENTS OF THE INVENTION

Solar collectors are known in the art. Example solar collectors are disclosed in U.S. Pat. Nos. 5,347,402, 4,056,313, 4,117,682, 4,608,964, 4,059,094, 4,161,942, 5,275,149, 5,195,503 and 4,237,864, the disclosures of which are hereby incorporated herein by reference. Solar collectors include at least one mirror (e.g., parabolic or other type of mirror) that reflects incident light (e.g., sunlight) to a focal location such as a focal point. In certain example instances, a solar collector includes one or more mirrors that reflect incident sunlight and focus the light at a common location. For instance, a liquid to be heated may be positioned at the focal point of the mirror(s) so that the reflected sunlight heats the liquid (e.g., water, oil, or any other suitable liquid) and energy can be collected from the heat or steam generated by the liquid.

FIG. 1 is a schematic diagram of a conventional solar collector, or a part thereof, where a parabolic mirror 1 reflects incident light (or radiation) from the sun 3 and focuses the reflected light on a black body 5 that absorbs the energy of the sun's rays and is adapted to transfer that energy to other apparatus (not shown). By way of example only, the black body 5 may be a conduit through which a liquid or air flows where the liquid or air absorbs the heat for transfer to another apparatus. As another example, the black body 5 may be liquid itself to be heated, or may include one or more solar cells in certain example instances.

FIG. 2 is a cross sectional view of a typical mirror used in conventional solar collector systems. The mirror of FIG. 2 includes a reflective coating 7 supported by a bent glass substrate 9, where the glass substrate 9 is on the light incident side of the reflective coating 7 (i.e., the incident light from the sun must pass through the glass before reaching the reflective coating). This type of mirror is a second or back surface mirror. Incoming light passes through the glass substrate 9 before being reflected by the coating 7; the glass substrate 9 is typically from about 4-5 mm thick. Thus, reflected light passes through the glass substrate twice in back surface mirrors; once before being reflected and again after being reflected on its way to a viewer. Second or back surface mirrors, as shown in FIG. 2, are used so that the glass 9 can protect the reflective coating 7 from the elements in the external or ambient atmosphere in which the mirror is located (e.g., from rain, scratching, acid rain, wind-blown particles, and so forth).

Conventional reflectors such as that shown in FIG. 2 are typically made as follows. The glass substrate 9 is from about 4-5 mm thick, and is heat-bent using temperatures of at least about 580 degrees C. The glass substrate 9 is typically heat/hot bent on a parabolic mold using such high temperatures, and the extremely high temperatures cause the glass to sag into shape on the parabolic mold. After the hot bent glass is permitted to cool to about room temperature, a reflective coating (e.g., silver based coating) is formed on the bent glass substrate. Ceramic pads may then be glued to the panel which may be bolted to a holding structure of the solar collector.

Unfortunately, the aforesaid process of manufacturing reflectors is problematic for at least the following reasons. First, the hot bending (using temperatures of at least 580 degrees C.) may cause distortions in the glass on which the coating is applied, which can lead to optical deficiencies. Second, application of a reflective coating onto a pre-bent glass substrate is difficult at best, and often leads to reduced reflective/mirror quality.

Thus, it will be appreciated that there exists a need in the art for a more efficient technique for making bent reflective coated articles. An example of such an article is a mirror which may be used in solar collector applications or the like.

In certain example embodiments of this invention, a reflector for a solar collector or the like is made by (a) forming a reflective coating on a flat glass substrate, (b) cold-bending the glass substrate with the reflective coating thereon using a mold member; and (c) applying a plate or frame member to the cold-bent glass substrate, the plate or frame member (which may be another glass sheet, or alternatively may be a thermoplastic member) for maintaining the coated glass substrate in a bent orientation. The coating may be a single layer coating, or a multi-layer coating, in different example embodiments of this invention. In certain example embodiments of this invention, the glass substrate with the coating thereon may be bent at a temperature of no more than about 200 degrees C., more preferably no more than about 150 degrees C., more preferably no more than about 100 degrees C., even more preferably no more than about 75 degrees C., still more preferably no more than about 50 degrees C., still more preferably no more than about 40 or 30 degrees C., and most preferably at about room temperature.

In certain example embodiments, the plate or frame member may be flat and may be applied to the flat glass substrate prior to bending thereof. Then, the plate member (e.g., of a thermoplastic or the like) and the glass substrate can be bent together with the plate or frame member optionally being pre-heated to permit more efficient bending thereof. In other example embodiments of this invention, the plate or frame member may be another glass substrate/sheet, and may optionally have been pre-bent (e.g., via hot bending) prior to being laminated to the cold-bent glass substrate and/or reflective coating. The pre-bent glass substrate/sheet may be laminated/adhered to the cold-bent glass substrate with the reflective coating thereon via an adhesive/laminating layer which is typically polymer based (e.g., PVB).

In certain example embodiments, the reflective coating is specially designed to as to better adhere to a polymer based adhesive/laminating layer that is used to couple the plate member (e.g., glass sheet) to the cold-bent glass substrate. For example, in certain example embodiments, the reflective coating is a mirror coating and includes a passivating film comprising tin oxide and/or silane(s), instead of copper and paint, for better adhering to the polymer based adhesive/laminating layer which may be made of polyvinyl butyral (PVB) or the like.

In certain example embodiments of this invention, there is provided a method of making a mirror, the method comprising: providing a flat glass substrate; forming a mirror coating on the flat glass substrate, the mirror coating including a reflective layer and an uppermost film comprising tin oxide and/or silane(s); after the mirror coating has been formed on the flat glass substrate, bending the glass substrate together with the coating thereon into a desired bent shape, the bending being performed when the glass substrate is at a temperature of no more than about 200 degrees C.; and maintaining the glass substrate and the coating thereon in substantially the desired bent shape by using a plate that is laminated to the glass substrate using a polymer based glue layer, so that the polymer based glue layer directly contacts the uppermost film of the mirror coating which comprises tin oxide and/or silane(s).

In other example embodiments of this invention, there is provided a method of making a mirror, the method comprising: providing a flat glass substrate; forming a reflective coating on the flat glass substrate, the reflective coating including a reflective layer and an uppermost film comprising metal oxide and/or silane(s); after the reflective coating has been formed on the flat glass substrate, bending the glass substrate together with the coating thereon into a desired bent shape, the bending being performed when the glass substrate is at a temperature of no more than about 250 degrees C.; and maintaining the glass substrate and the coating thereon in substantially the desired bent shape by using a plate that is laminated to the glass substrate using a polymer based laminating layer, so that the polymer based laminating layer directly contacts the uppermost film of the reflective coating which comprises metal oxide and/or silane(s).

In still further example embodiments of this invention, there is provided a mirror, comprising: a first bent glass substrate with a mirror coating formed thereon, wherein the mirror coating comprises a reflective layer and an uppermost film comprising metal oxide and/or silane(s); a second bent glass substrate laminated to the first bent glass substrate using a polymer based glue layer, and wherein the polymer based glue layer directly contacts the uppermost film of the mirror coating which comprises metal oxide and/or silane(s).

In certain example embodiments of this invention, there is provided a method of making a mirror, the method comprising: providing a flat glass substrate; forming a reflective coating on the flat glass substrate; after the reflective coating has been formed on the flat glass substrate, bending the glass substrate together with the coating thereon into a desired bent shape, the bending being performed when the glass substrate is at a temperature of no more than about 200 degrees C.; and maintaining the glass substrate and the coating thereon in substantially the desired bent shape by using a pre-bent glass sheet and/or a thermoplastic member that is attached to the glass substrate and/or the coating thereon.

### BRIEF DESCRIPTION OF THE DRAWINGS

FIG. 1 is a schematic diagram of a conventional solar collector system.

FIG. 2 is a cross sectional view of the second surface mirror used in the conventional solar collector system of FIG. 1.

FIG. 3 illustrates a first step performed in making a bent reflecting according to an example embodiment of this invention.

FIG. 4 illustrates another step performed in making a bent reflecting according to an example embodiment of this invention.

FIG. 5 illustrates another step performed in making a bent reflecting according to an example embodiment of this invention.

FIG. 6 illustrates another step performed in making a bent reflecting according to an example embodiment of this invention.

FIG. 7 illustrates yet another step performed in making a bent reflecting according to an example embodiment of this invention.

FIG. 8 illustrates another optional step performed in making a bent reflecting according to an example embodiment of this invention.

FIG. 9 is a cross sectional view of a reflector according to an embodiment of this invention, where a second surface mirror may be used such that the reflective coating is provided on the side of the glass substrate opposite the light incident side.

FIG. 10 is a cross sectional view of a reflector according to an embodiment of this invention, where a first surface mirror may be used such that the reflective coating is provided on the light incident side of the glass substrate.

FIG. 11 is a flowchart illustrating steps performed in making a mirror according to another example embodiment of this invention.

FIG. 12 is a cross sectional view of the mirror made in the FIG. 11-12 embodiment.

FIG. 13 is a flowchart illustrating steps performed in making a mirror according to yet another example embodiment of this invention.

FIG. 14 is a cross sectional view of the mirror made in the FIG. 13-14 embodiment.

FIG. 15 is a cross sectional view of a mirror made in any of the FIG. 11-14 embodiments.

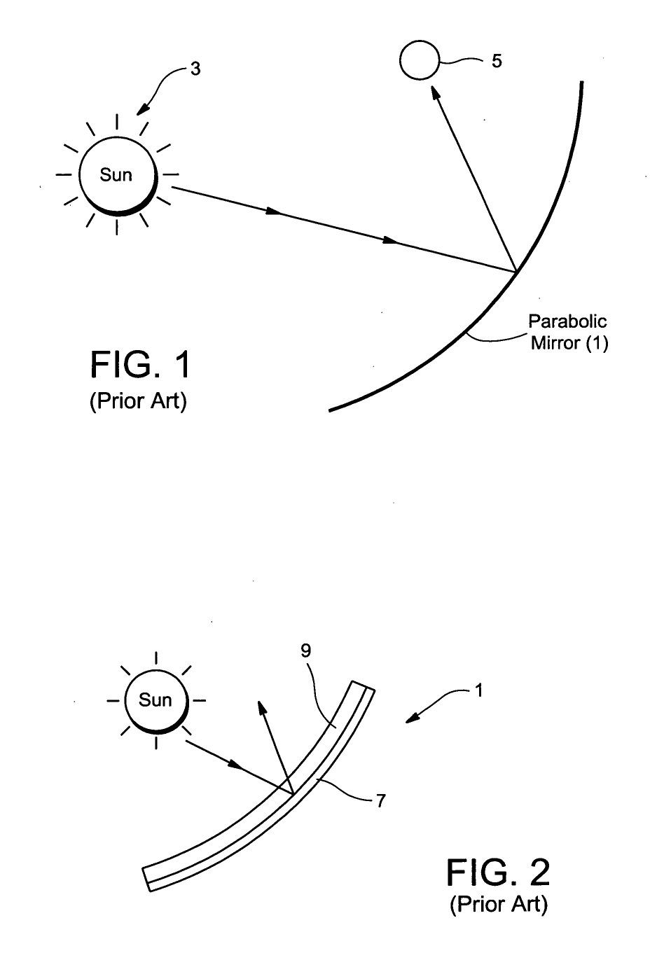

### DETAILED DESCRIPTION OF EXAMPLE EMBODIMENTS OF THE INVENTION

Referring now more particularly to the accompanying drawings in which like reference numerals indicate like parts throughout the several views.

In certain example embodiments of this invention, a reflector for a solar collector or the like is made by (a) forming a reflective coating on a flat glass substrate, (b) cold-bending the glass substrate with the reflective coating thereon using a mold member; and (c) applying a plate member to the cold-bent glass substrate, the plate member for maintaining the coated glass substrate in a bent orientation. The plate member may be another glass substrate/sheet in certain example embodiments, or alternatively may be a thermoplastic sheet in other example embodiments. In certain example embodiments of this invention, the glass substrate with the coating thereon may be bent at a temperature of no more than about 200 degrees C., more preferably no more than about 150 degrees C., more preferably no more than about 100 degrees C., even more preferably no more than about 75 degrees C., still more preferably no more than about 50 degrees C., still more preferably no more than about 40 or 30 degrees C., and possibly at about room temperature in certain example instances.

In certain example embodiments of this invention, the reflector may be used as a mirror in a solar collector, or in any other suitable application. In certain example embodiments of this invention, the reflector is a mirror (first or second surface mirror) which may be used in applications such as one or more of: parabolic-trough power plants, compound parabolic concentrating collectors, solar dish-engine systems, solar thermal power plants, and/or solar collectors, which rely on mirror(s) to reflect and direct solar radiation from the sun. In certain example instances, the mirror(s) may be mounted on a steel or other metal based support system. In certain example embodiments, the reflector may be an IR reflecting coated article that may be used in window or other applications. In such IR reflecting embodiments, the reflective coating may include at least one infrared (IR) reflecting layer of or including a material such as silver, gold, or the like, and may be at least partially transmissive to visible light while blocking significant amounts of IR radiation, and may be used in window or other suitable applications.

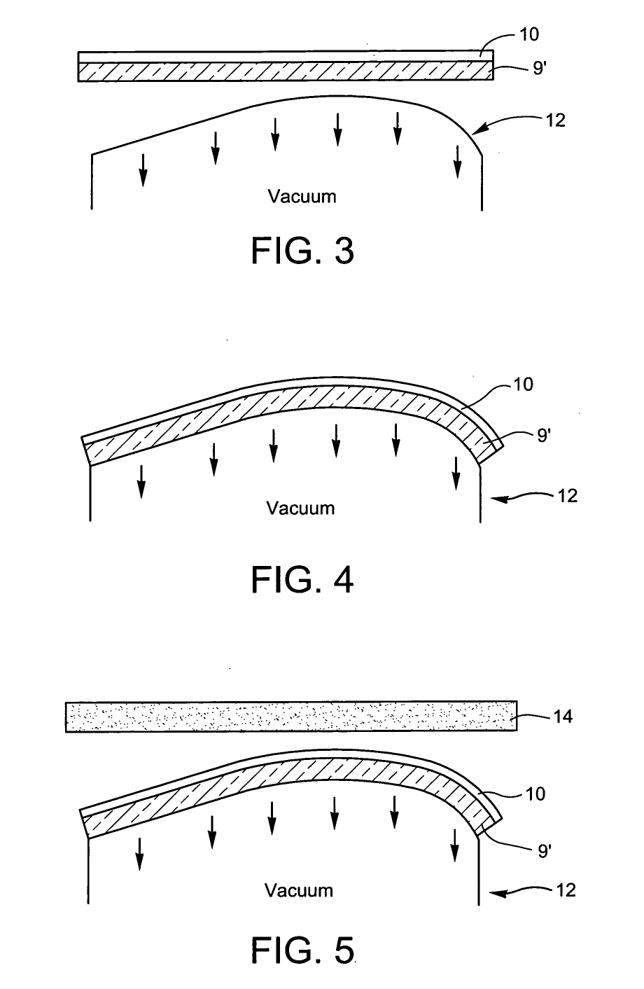

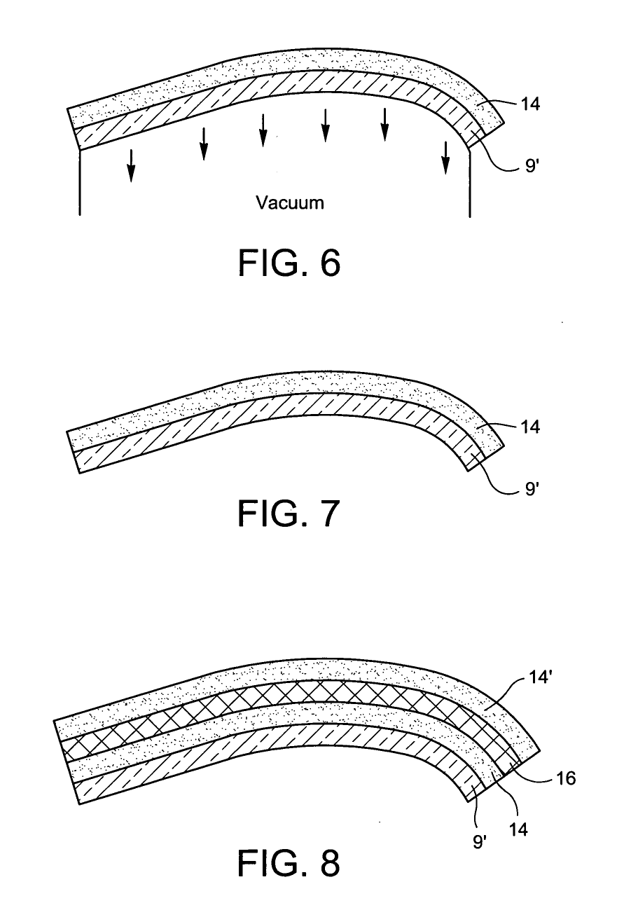

FIGS. 3-8 illustrate an example process of making a reflector according to an example embodiment of this invention. First, a flat glass substrate (e.g., soda-lime-silica based float glass) 9′ is provided in uncoated form. The flat glass substrate 9′ may be clear or green colored, and may be from about 0.5 to 2.5 mm thick, more preferably from about 1.0 to 2.25 mm thick, and most preferably from about 1.0 to 2.0 mm thick. Then, a reflective coating 10 is formed on the flat glass substrate 9′ via sputtering, sol-gel, spraying, or the like. The reflective coating 10 is shown in FIGS. 3-5 and 9-15, but is not shown in FIGS. 6-8 for purposes of simplicity. The reflective coating 10 may be made up of a single reflective layer, or alternatively may be made up of a plurality of layers in different instances. In single layer embodiments, the reflective coating 10 may be made up of a single reflective layer of aluminum, silver, chromium, gold or the like that is sufficient to reflect the desired radiation (e.g., visible and/or IR radiation). In multi-layer embodiments, the reflective coating 10 may include a reflective layer of aluminum, silver, chromium, gold or the like and other layer(s) such as silicon oxide, silicon nitride which may be provided over and/or under the reflective layer. Other example reflective coatings 10 are set forth in U.S. Patent Document Nos. 2003/0179454, 2005/0083576, Ser. Nos. 10/945,430, 10/959,321, U.S. Pat. Nos. 6,783,253, 6,251,482, 3,798,050, or 6,934,085, any of which may be used herein, the disclosures of which are hereby incorporated herein by reference.

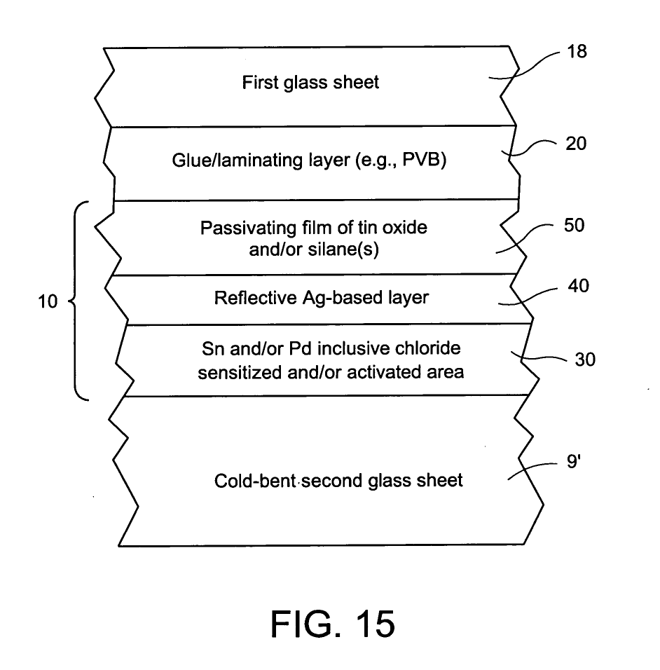

An example of a multi-layer reflective coating 10 especially designed for adherence to a laminating layer is shown in FIG. 15.

In certain example mirror embodiments, the reflective layer (e.g., Al, Ag, Au or Cr based layer) of the coating 10 may have an index of refraction value “n” of from about 0.05 to 1.5, more preferably from about 0.05 to 1.0. When the reflective layer of the coating 10 is of or based on Al, the index of refraction “n” of the layer may be about 0.8, but it also may be as low as about 0.1 when the layer is of or based on Ag. In certain example embodiments of this invention, a reflective metallic layer of Ag may be applied at a silvering station where a silvering solution is sprayed on, the silvering solution including a silver salt and a reducing agent(s). In other example embodiments, a reflective layer of Al may be sputtered onto the glass substrate 9′, directly or indirectly, using a C-MAG rotatable cathode Al inclusive target (may or may not be doped) and/or a substantially pure Al target (>=99.5% Al) (e.g., using 2 C-MAG targets, Ar gas flow, 6 kW per C-MAG power, and pressure of 3 mTorr), although other methods of deposition for the layer may be used in different instances. The reflective layer(s) of the coating 10 in certain embodiments of this invention has a reflectance of at least 75% in the 500 nm region as measured on a Perkin Elmer Lambda 900 or equivalent spectrophotometer, more preferably at least 80%, and even more preferably at least 85%, and in some instances at least about 90% or even 95%. Moreover, in certain embodiments of this invention, the reflective layer is not completely opaque, as it may have a small transmission in the visible and/or IR wavelength region of from 0.1 to 5%, more preferably from about 0.5 to 1.5%. The reflective layer may be from about 20-150 nm thick in certain embodiments of this invention, more preferably from about 40-90 nm thick, even more preferably from about 50-80 nm thick, with an example thickness being about 65 nm when Al is used for the reflective layer.

It is advantageous that the reflective coating 10 is formed (e.g., via sputtering or the like) on the glass 9′ when the glass is in a flat form, as shown in FIG. 3. This permits the coating to be formed in a more consistent and uniform manner, thereby improving the reflective characteristics thereof so that the final product may achieve improved optical performance (e.g., better and/or more consistent reflection of visible and/or IR radiation).

Once the reflective coating 10 has been formed on the flat glass substrate 9′ to form a coated article as shown in FIG. 3, the flat coated article is positioned over a mold 12. The mold 12 may be in the shape of a parabolic or the like, to which it is desired to bend the coated article. Moreover, as shown in FIG. 3, the mold 12 may have a plurality of holes defined therein for drawing a vacuum to help bend the coated article. The coated article including the glass 9′ and reflective coating 10 is positioned over and lowered onto the surface of the mold 12. The coated article, including the glass 9′ and coating 10 thereon, is then cold-bent along the parabolic surface of the mold 12 as shown in FIG. 4. The cold-bending may be achieved via a gravity sag on the parabolic surface of the mold 12, with the optional help of the vacuum system which helps draw the coated article toward the parabolic mold surface 12. In certain example embodiments, the glass 9′ may directly contact the parabolic bend surface of the mold 12 during the bending process.

The bending of the coated glass article shown in FIGS. 3-4 is a cold-bend technique, because the glass is not heated to its typical bending temperature(s) of at least about 580 degrees C. Instead, during the bending of FIGS. 3-4, the glass substrate 9′ with the coating 10 thereon may be bent while at a temperature of no more than about 200 degrees C., more preferably no more than about 150 degrees C., more preferably no more than about 100 degrees C., even more preferably no more than about 75 degrees C., still more preferably no more than about 50 degrees C., still more preferably no more than about 40 or 30 degrees C., and possibly at about room temperature in certain example instances. In order to not exceed the maximum tensile stress (e.g., 20.7 to 24.15 MPa) that would lead to spontaneous breakage of the glass during cold bending in this configuration, the thickness of glass substrate 9′ is kept relatively thin. For example, in certain example embodiments of this invention, the glass 9′ is from about 0.5 to 2.5 mm thick, more preferably from about 1.0 to 2.25 mm thick, and most preferably from about 1.0 to 2.0 mm thick.

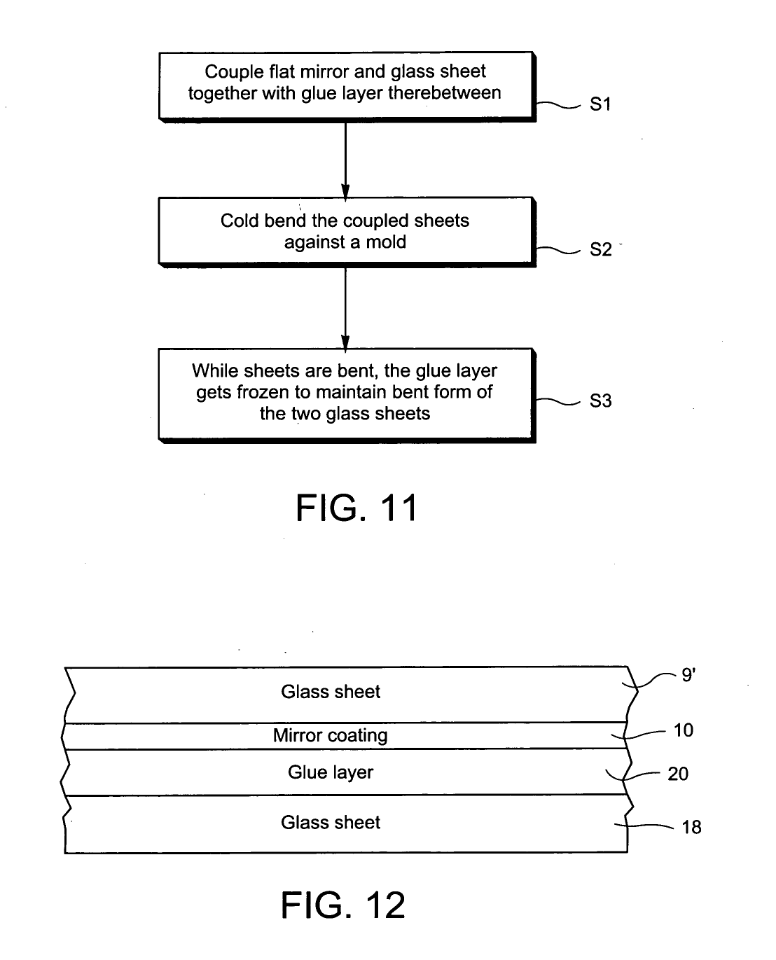

After the coated article including the glass 9′ and coating 10 has been cold-bent to its desired shape (e.g., parabolic shape) as shown in FIG. 4, this bent shape is maintained using a plate/frame 14 such as another glass sheet or a thermoplastic on which the coated article may be glued or otherwise adhered (see FIG. 5). Optionally, addition of an adequate adhesive agent (not shown), or an adhesive/laminating layer 20 as shown in FIGS. 11-15, may be used to caused excellent adhesion between the coated article and the plate 14. The plate 14 may be transparent or opaque in different embodiments of this invention. The plate 14 may or may not be pre-bent in a shape corresponding to the cold-bent substrate in different example embodiments of this invention. The plate 14 may be attached to the cold-bent glass 9′ (and thus to the reflective coating thereon) via an adhesive/laminating layer and/or via fasteners in different example embodiments of this invention, in order to freeze its bent shape around the exterior of the coated article made up of the cold-bent glass 9′ and the reflective coating 10. The cold-bent article may then be removed from the mold as shown in FIG. 7. The bent/shaped plate 14 then maintains the bent shape of the cold-bent glass 9′ to which it is adhered and/or fastened, thereby keeping the glass 9′ and coating 10 thereon in a desired bent shape/form, as shown in FIG. 7.

Note that it is possible to use stiffening material (e.g., glass fibers or the like) in the plate 14 so provide the plate 14 with substantially the same dilatation properties as the glass 9′ (e.g., embedded glass fibers in polypropylene). Optionally, the plate 14 may also cover the edges of the glass 9′ and coating 10 so as to function as a mechanical protector to protect the edges of the glass and possibly prevent or reduce oxidation or degradation of the glass 9′ and/or coating 10.

Optionally, as shown in FIG. 8, spacers (e.g., honeycomb spacers) 16 may optionally be provided and another similarly bent plate 14′ on the bent glass substrate 9′ over the plate 14 is also possible. The combination of layers 14, 16 and 14′ may be applied together at the same time as one unit on the glass 9′, or alternatively may be applied sequentially as separate layers in different example embodiments of this invention.

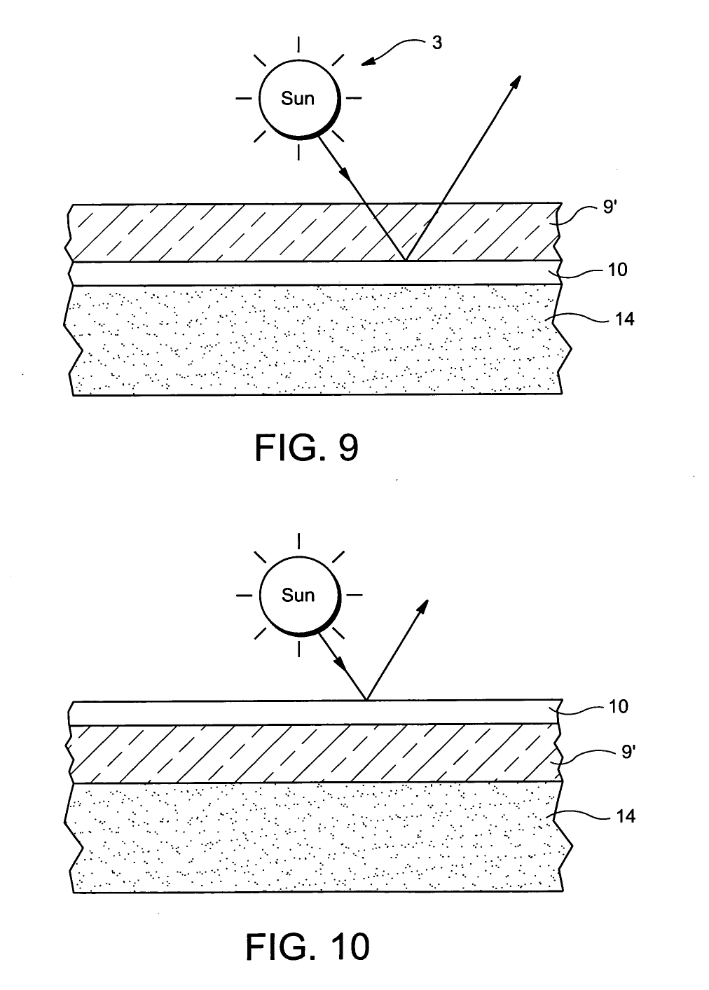

FIGS. 9-10 are cross sectional views of portions of bent mirrors according to different example embodiments of this invention, and illustrate that first surface mirrors (FIG. 10) or back surface mirrors (FIG. 9) may be used in different instances. FIG. 9 illustrates that the mirror is a back or second surface mirror because the incident light from the sun has to first pass through the glass 9′ before being reflected by coating 10.

Certain example embodiments of this invention are advantageous for a number of reasons. For example and without limitation, the thin glass 9′ used in the bending process is advantageous in that it permits high reflection characteristics to be realized, low weight characteristics and reduces constraints on the reflective coating. The cold-bending is advantageous in that it reduces distortions of the glass 9′ and/or coating 10 and provides for good shape accuracy, and the application of the coating 10 to the glass 9′ when the glass is in a flat form allows for improved mirror and/or reflective qualities to be realized. Moreover, the laminate nature of the product, with the plate 14 being adhered to the glass 9′, provides for better safety and allows the reflector to perform even if it should be cracked or broken.

In certain example embodiments of this invention, plate 14 may be a glass sheet that is adhered to the cold-bent glass 9′ and coating 10 via a glue layer. A glue layer may also be referred to as a laminating layer or an adhesive layer. Such examples are shown with reference to FIGS. 11-15.

Referring to FIGS. 11-12, a flat glass substrate (e.g., soda-lime-silica based float glass) 9′ is provided in uncoated form. The flat glass substrate 9′ may be clear or green colored, and may be from about 0.5 to 2.5 mm thick, more preferably from about 1.0 to 2.25 mm thick, and most preferably from about 1.0 to 2.0 mm thick. Then, a reflective coating 10 (e.g., any mirror coating discussed herein, or any other suitable mirror coating) is formed on the flat glass substrate 9′ via sputtering, sol-gel, spraying, wet chemical application, and/or the like. As discussed above, the reflective coating 10 may be made up of a plurality of layers. In multi-layer embodiments, the reflective coating 10 may include a reflective layer of silver, aluminum, chromium, gold or the like and other layer(s) which may be provided over and/or under the reflective layer. Other example reflective coatings 10 are set forth in U.S. Patent Document Nos. 2003/0179454, 2005/0083576, Ser. Nos. 10/945,430, 10/959,321, U.S. Pat. Nos. 6,783,253, 6,251,482, 3,798,050, or 6,934,085, any of which may be used herein, the disclosures of which are hereby incorporated herein by reference. It is advantageous that the reflective coating 10 is formed (e.g., via sputtering, spraying, wet chemical application, sol-gel, and/or the like) on the glass 9′ when the glass is in a flat form; as this permits the coating to be formed in a more consistent and uniform manner thereby improving the reflective characteristics thereof so that the final product may achieve improved optical performance (e.g., better and/or more consistent reflection of visible and/or IR radiation).

Then, in the FIG. 11-12 embodiment, the coated article including flat glass substrate 9′ with reflective coating 10 thereon is coupled to another flat glass substrate 18 with a glue layer 20 provided therebetween (see step S1 in FIG. 11). The glue layer 20 may be made up of a polymer based material in certain example instances. In certain example embodiments, the glue/adhesive/laminating layer 20 may be made of or include polyvinyl butyral (PVB) or any other suitable polymer based glue material. The glue layer may be initially provided between the glass substrates 9′ and 18 in solid and/or non-adhesive form. Then, the multi-layer structure shown in FIG. 12 including glass substrates 9′ and 18, with reflective coating 10 and glue layer 20 therebetween, is cold bent on a mold 12 as described above (e.g., see S2 in FIG. 11, and FIGS. 3-4). The curved mold 12 may be made of steel or any other suitable material. Because the glue layer may not be in final adhesive form at this point, the glass substrates 9′ and 18 together with the coating 10, glue layer 20 and mold can be maintained in the bent sandwich form by mechanical clamps around the edges of the sandwich, or by any other suitable means. While the multi-layer structure is in its desired cold-bent form on the mold (e.g., with the clamps holding the sandwich in cold-bent form on the mold 10), the glue layer (e.g., PVB) 20 is heated and frozen in an adhesive position in order to maintain the glass substrates 9′ and 18 of the laminate in their desired bent form (see S3 in FIG. 11). The mold may then be removed. In order to “freeze” the glue layer 20, for example and without limitation, the glass substrates 9′ and 18 together with the coating 10, glue layer 20 and mold (e.g., possibly with the clamps) in the bent sandwich form can be positioned in a heating oven (e.g., autoclave) (not shown) and heating caused in the oven can cause the glue layer (e.g., PVB) 20 to turn into an adhesive which adheres the two substrates 9′ and 18 to each other (i.e., “freeze” the glue layer). After heating and curing of the glue layer 20, the mold may be removed. The now final adhesive glue layer 20, as heated and cured, can function to maintain the cold-bent glass substrates/sheets 9′ and 18 in their desired bent form along with coating 10.

It is noted that in the FIG. 11-12 embodiment, the reflective coating 10 may be on either major surface of the glass substrate 9′. Thus, the coating 10 may or may not directly contact the glue layer 20.

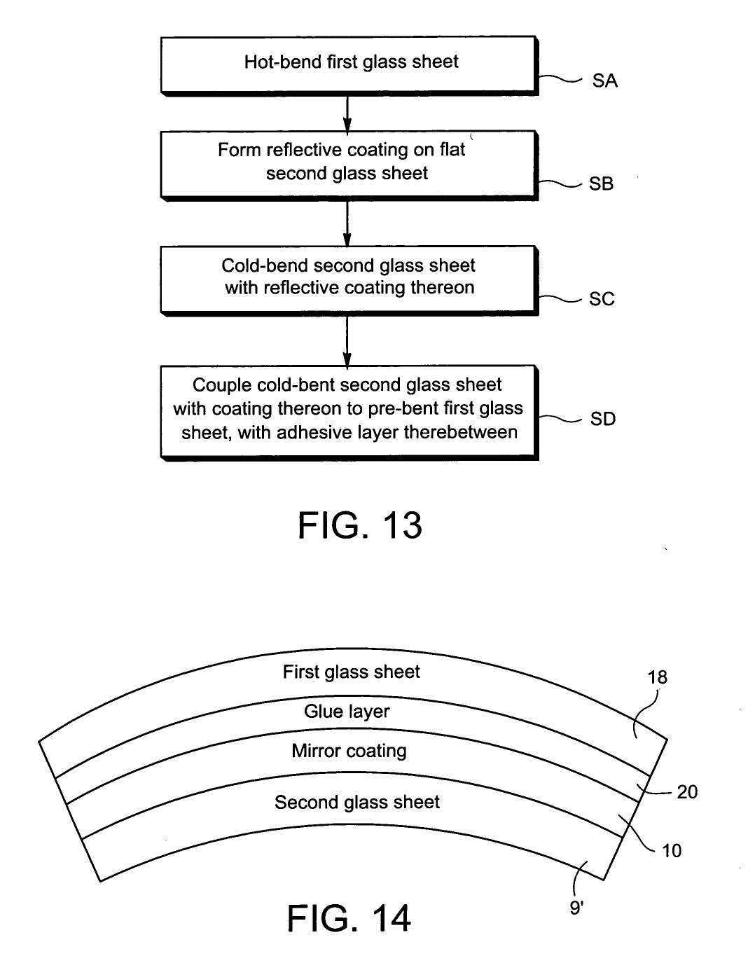

In certain example embodiments of this invention, the plate 14 may be a pre-bent glass sheet (e.g., which may be hot-bent). Such an example embodiment where the plate 14 is a pre-bent glass sheet is explained with respect to FIGS. 13-14.

Referring to the FIG. 13-14 embodiment, a pre-bent first sheet of glass 18 is provided in step SA. This pre-bent first sheet/substrate of glass 18 may be bent by heat-bending as is known in the art, e.g., using bending temperature(s) of at least about 550 degrees C., more preferably of at least about 580 degrees C. The first glass sheet 18 may be heat bent in any suitable manner, such as sag bending and/or using a bending mold. Additionally, a flat second glass substrate (e.g., soda-lime-silica based float glass) 9′ is provided in uncoated form. Like the first glass sheet/substrate 18, the flat second glass substrate 9′ may be clear or green colored, and may be from about 0.5 to 2.5 mm thick, more preferably from about 1.0 to 2.25 mm thick, and most preferably from about 1.0 to 2.0 mm thick. A reflective coating 10 is formed on the flat second glass substrate 9′ via sputtering, spraying, sol-gel, and/or the like, in step SB. Note that the order of steps SA and SB shown in FIG. 13 may be reversed, so that step SB is performed before or at the same time as step SA in certain example instances.

Still referring to at least FIGS. 13-14, once the reflective coating 10 has been formed on the flat second glass substrate 9′ to form a coated article as shown in FIG. 3 for instance, the flat coated article is positioned over a mold 12. The mold 12 may be in the shape of a parabolic or the like, to which it is desired to bend the coated article. Moreover, as shown in FIG. 3, the mold 12 may have a plurality of holes defined therein for drawing a vacuum to help bend the coated article. The coated article including the glass 9′ and reflective coating 10 thereon is positioned over and lowered onto the surface of the mold 12. The coated article, including the glass 9′ and coating 10 thereon, is then cold-bent along the parabolic surface of the mold 12 as shown in FIG. 4 in step SC of FIG. 13. The cold-bending in step SC may be achieved via a gravity sag on the parabolic surface of the mold 12, with the optional help of the vacuum system which helps draw the coated article toward the parabolic mold surface 12. In certain example embodiments, the glass 9′ may directly contact the parabolic bend surface of the mold 12 during the bending process. The bending of the coated glass article shown in FIGS. 3-4 and in step SC of FIG. 13 is a cold-bend technique, because the glass is not heated to its typical bending temperature(s) of at least about 550 or 580 degrees C. Instead, during cold-bending the glass substrate 9′ with the coating 10 thereon may be bent while at a temperature of no more than about 250 or 200 degrees C., more preferably no more than about 150 degrees C., more preferably no more than about 100 degrees C., even more preferably no more than about 75 degrees C., still more preferably no more than about 50 degrees C., still more preferably no more than about 40 or 30 degrees C., and possibly at about room temperature in certain example instances. In order to not exceed the maximum tensile stress (e.g., 20.7 to 24.15 MPa) that would lead to spontaneous breakage of the glass during cold bending in this configuration, the thickness of second glass substrate 9′ may be kept relatively thin.

After the coated article including the second glass substrate/sheet 9′ and coating 10 has been cold-bent to its desired shape (e.g., parabolic shape) in step SC of FIG. 13 and as shown in FIG. 4, this bent shape is maintained using the pre-hot-bent first glass substrate/sheet 18 that was formed in step SA. In certain example embodiments, the pre-hot-bent first glass sheet 18 is laminated or otherwise coupled to the cold-bent second glass sheet 9′ with an adhesive/glue layer 20 therebetween as shown in FIGS. 13-15 and as noted in step SD of FIG. 13. The pre-bent glass sheet 18 together with the glue layer 20 then maintain the bent shape of the glass 9′ to which it is adhered and/or fastened, thereby keeping the glass 9′ and reflective coating 10 thereon in a desired bent shape/form, as shown in FIG. 14. In certain example embodiments of this invention, the glue layer 20 may be made of any suitable adhesive material including but not limited to polyvinyl butyral (PVB). This glue layer 20 is similar to the glue or laminating layers that are used to adhere glass substrates of vehicle windshields to one another. It is noted that in the FIG. 13-14 embodiment, the reflective coating 10 may be on either major surface of the glass substrate 9′. Thus, the coating 10 may or may not directly contact the glue layer 20.

However, with respect to the FIG. 13-14 embodiment, note that a second or back surface mirror is preferably used as shown in FIG. 15. In other words, the reflective coating 10 is preferably formed on the interior surface of glass sheet 9′ so as to directly contact the laminating/glue layer 20. In such embodiments, light is typically incident on the second glass sheet 9′, passes through glass sheet 9′ and is reflected by reflective coating 10 in a mirror-like manner back through sheet 9′ and toward the desired location for solar collector applications and the like.

In the FIG. 11-14 embodiments, there may be a problem of adhering the reflective coating 10 to the polymer-based glue/adhesive/laminating layer 20 which may be made of PVB or the like, in certain instances. A specially designed reflective coating 10 is shown in FIG. 15 for solving this problem, and may be used in conjunction with any embodiment herein.

Conventional parabolic mirrors use a curved bent glass sheet that has been silvered using a conventional commercial process. In such processes, mirrors are formed as follows: a glass substrate, a tin monolayer, a silver layer for reflective purposes, a copper layer, and then backing paint. The tin monolayer promotes adhesive of silver to glass and is typically applied as a tin chloride spray. Next, the reflective silver layer (e.g., about 70 nm thick) is applied by spraying, followed by the passivating metallic copper layer. The copper layer may be formed by precipitating copper from a solution of one of its salts. Finally, the mirror backing paint is applied (e.g., in two steps to achieve a desired thickness around 80 microns). For each layer of paint, the mirror is passed through an oven for curing purposes. The paint provides for a mechanical and chemical barrier to protect the reflective silver layer. However, unfortunately, the backing paint of typical mirror coatings is relatively inert and forms a poor surface for adhesion to polymer-based glue/adhesion/laminating layers 20 such as PVB. Thus, the coating of FIG. 15 is provided to solve this problem.

The mirror coating 10 of the FIG. 15 embodiment may be used in conjunction with any embodiment herein, especially in connection with the FIG. 11-14 embodiments. In the FIG. 15 embodiment, the backing paint and copper (Cu) layers of a conventional mirror are removed, or substantially removed, and replaced with a passivating film of tin oxide and/or silane(s). The silane(s) and/or tin oxide are better able to couple to functional groups such as hydroxyls and aldehydes within the glue layer (e.g., PVB) 20. Thus, the mirror coating 10 of the FIG. 15 embodiment better able to adhere to the laminating/glue layer 20 so that a more durable and improved product is provided.

The mirror coating of the FIG. 15 embodiment may be made as follows in certain example embodiments of this invention. Flat glass sheet 9′ is provided. The glass sheet 9′ may be polished, rinsed and then sensitized by way of a tin chloride solution, and then optionally rinsed. The tin chloride solution, which may possible be a stannous chloride solution in certain instances, may provide for a tin monolayer on the surface of the glass substrate/sheet 9′. Optionally, then, an activating solution including ions of at least one of bismuth (III), chromium (II), gold (III), indium (III), nickel (II), palladium (II), platinum (II), rhodium (III), ruthenium (III), titanium (III), vanadium (III) and zinc (II) is then used to active the substrate prior to silvering. For example, an aqueous solution of or including PdCl₂ may be sprayed onto the sheet for activation purposes, for better anchoring of the silver. Thus, for example, a tin (Sn) and/or palladium (Pd) inclusive chloride sensitized and/or activated area 30 may be provided on the surface of the glass 9′ as shown in FIG. 15. The activated glass may then proceed to a rinsing station where demineralized water for example may be sprayed, and then to a silvering station where silvering solution is sprayed onto the sheet to form reflective silver layer 40. The silvering solution, in certain example embodiments, may be of or include a silver salt and a reducing agent(s). The silver based reflective layer 40 may be from about 40-100 nm thick in certain example instances, with an example being about 70 nm). The glass may then be rinsed, and then an acidified solution of tin chloride may be sprayed onto the silvered glass. This tin solution may ultimately form tin oxide on the surface of the coating. Then, the mirror may be treated by spraying it with a solution containing at least one silane. For example, the mirror may be treated by spraying it with a solution including γ-aminopropyl triethoxysilane. Any other silane(s) may instead or also be formed on the surface of the coating. Moreover, it is noted that tin oxide and silane(s) may simultaneously be formed over the silver based layer in certain example embodiments of this invention, or alternatively the silane may be formed prior to the tin oxide. In any event, a passivating film 50 including at least one layer and including one or both of tin oxide and at least one silane is provided as part of the coating 10 over the silver based reflective layer 40. This passivating film 50, including the tin oxide and/or silane, directly contacts the polymer-based glue layer 20 during the laminating phase, and provides an improved bonding thereto as explained above.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of making a mirror, the method comprising:
providing a flat glass substrate;
forming a mirror coating on the flat glass substrate, the mirror coating including a reflective layer and an uppermost film comprising tin oxide and/or silane(s);
after the mirror coating has been formed on the flat glass substrate, bending the glass substrate together with the coating thereon into a desired bent shape, the bending being performed when the glass substrate is at a temperature of no more than about 200 degrees C.; and
maintaining the glass substrate and the coating thereon in substantially the desired bent shape by using a plate that is laminated to the glass substrate using a polymer based glue layer, so that the polymer based glue layer directly contacts the uppermost film of the mirror coating which comprises tin oxide and/or silane(s).

2. The method of claim 1, wherein said bending of the glass substrate with the coating thereon is performed when the glass substrate is at a temperature of no more than about 150 degrees C.

3. The method of claim 1, wherein said bending of the glass substrate with the coating thereon is performed when the glass substrate is at a temperature of no more than about 100 degrees C.

4. The method of claim 1, wherein said bending of the glass substrate with the coating thereon is performed when the glass substrate is at a temperature of no more than about 50 degrees C.

5. The method of claim 1, wherein said bending of the glass substrate with the coating thereon is performed when the glass substrate is at approximately room temperature.

6. The method of claim 1, wherein said plate is a glass sheet.

7. The method of claim 1, wherein said plate is a glass sheet that is pre-bent before being laminated to the glass substrate.

8. The method of claim 1, wherein the glass substrate is from about 1.0 to 2.25 mm thick.

9. The method of claim 1, wherein the polymer based glue layer comprises polyvinyl butyral.

10. The method of claim 1, wherein the reflective layer of the mirror coating comprises silver.

11. The method of claim 1, wherein in making the mirror coating, a solution comprising PdCl₂ is sprayed toward the glass substrate prior to forming of the reflective layer.

12. The method of claim 1, wherein the bent shape comprises a substantially parabolic shape, and wherein the mirror is used as a mirror in a solar collector.

13. The method of claim 1, wherein the uppermost film of the mirror coating comprises tin oxide.

14. The method of claim 1, wherein the uppermost film of the mirror coating comprises at least one silane.

15. A method of making a mirror, the method comprising:
providing a flat glass substrate;
forming a reflective coating on the flat glass substrate, the reflective coating including a reflective layer and an uppermost film comprising metal oxide and/or silane(s);
after the reflective coating has been formed on the flat glass substrate, bending the glass substrate together with the coating thereon into a desired bent shape, the bending being performed when the glass substrate is at a temperature of no more than about 250 degrees C.; and
maintaining the glass substrate and the coating thereon in substantially the desired bent shape by using a plate that is laminated to the glass substrate using a polymer based laminating layer, so that the polymer based laminating layer directly contacts the uppermost film of the reflective coating which comprises metal oxide and/or silane(s).

16. A mirror, comprising:
a first bent glass substrate with a mirror coating formed thereon, wherein the mirror coating comprises a reflective layer and an uppermost film comprising metal oxide and/or silane(s);
a second bent glass substrate laminated to the first bent glass substrate using a polymer based glue layer, and wherein the polymer based glue layer directly contacts the uppermost film of the mirror coating which comprises metal oxide and/or silane(s).

17. The mirror of claim 16, wherein the uppermost film of the mirror coating comprises tin oxide.

18. The mirror of claim 16, wherein the uppermost film of the mirror coating comprises at least one silane.
